(19) United States
(12) Patent Application Publication
(10) Pub. No.: US 2022/0316808 A1
(43) Pub. Date: Oct. 6, 2022

(54) PLATE HEAT EXCHANGER, PROCESS ENGINEERING PLANT AND METHOD

(71) Applicant: Linde GmbH, Pullach (DE)

(72) Inventor: Thomas ENGLERT, Gilching (DE)

(21) Appl. No.: 17/597,285

(22) PCT Filed: Oct. 1, 2020
(86) PCT No.: PCT/EP2020/025443

§ 371 Date: Dec. 30, 2021

(30) Foreign Application Priority Data
Oct. 11, 2019 (EP) 19020569.0

(51) Int. Cl. F28D 9/00; F28F 3/02; F28F 21/08

(52) U.S. Cl. CPC F28D 9/0062; F28F 3/025; F28F 21/084; F28F 2275/045

(57) ABSTRACT

The invention relates to a plate heat exchanger for a process engineering plant, comprising a heat exchanger block which has a plurality of alternatingly arranged heating surface elements and separating plates, wherein the separating plates are soldered to the heating surface elements with the aid of solder layers provided at the separating plates, and wherein, in at least a part of the separating plates, the solder layers comprise at least two soldered areas that differ in terms of the alloy composition thereof.

The invention relates to a plate heat exchanger for a process engineering plant, a process engineering plant with such a plate heat exchanger, and a method for producing such a plate heat exchanger.

A plate heat exchanger comprises a heat exchanger block constructed of alternatingly arranged heating surface elements, in particular so-called fins or heat transfer fins, and separating plates. The heating surface elements are made of corrugated or ribbed aluminum sheets, whereas the separating plates are made of smooth aluminum sheets. The aforementioned components of the heat exchanger block are soldered, in particular brazed, together with the aid of an aluminum solder in a soldering furnace. The aluminum solder is applied to the separating plates before the components are soldered.

An aluminum soldering alloy having a relatively narrow and high melting range is usually used for soldering the components of the plate heat exchanger. In order to be able to solder the individual components of the heat exchanger block reliably together, it is therefore necessary to reach the melting temperature of the aluminum solder being used both in the core and at the edge of the heat exchanger block. Since the heat exchanger block heats up slowly from its edge towards its core in the soldering furnace, the aluminum solder at the edge of the heat exchanger block is in a molten range for several hours. In contrast, the aluminum solder in the core is only in the molten range for a few minutes.

This can result in long soldering times, which should be avoided in the interests of economic production. Furthermore, unfavorable effects and reactions can occur between the separating plates and the heating surface elements due to the long soldering times at the edge of the heat exchanger block. Particularly the local formation of low-melting Al—Si eutectics, which may have a negative impact due to erosion phenomena on the heating surface elements, should be avoided. In this case, holes and/or notches can be eaten into the heating surface elements, which can manifest as a lower burst pressure or operating pressure than in the qualifications of the heating surface elements. In particular with higher and wider designs of the heat exchanger block, this can represent a strongly limiting factor. This too should be avoided.

Against this background, an object of the present invention is to provide an improved plate heat exchanger for a process engineering plant.

Accordingly, a plate heat exchanger for a process engineering plant is proposed. The plate heat exchanger has a heat exchanger block comprising a plurality of alternatingly arranged heating surface elements and separating plates, wherein the separating plates are soldered to the heating surface elements with the aid of solder layers provided at the separating plates, and wherein, in at least a part of the separating plates, the solder layers comprise at least two solder areas that differ in their alloy compositions.

Since the solder layers comprise at least two solder areas that differ in their alloy compositions, it is possible to adjust the solder layers of the individual separating plates with regard to their melting ranges such that all solder areas melt simultaneously when the heat exchanger block is heated in a soldering furnace, even when the heat exchanger block does not have the same temperature in its core as at its edge. On the one hand, this can reduce soldering times and, on the other hand, can prevent the formation of low-melting Al—Si eutectics. Higher burst pressures can thereby be achieved and size limitations in the design of the heat exchanger block disappear.

The plate heat exchanger is in particular a so-called plate-fin heat exchanger (PFHE) or may be referred to as such. The heating surface elements are so-called fins, in particular so-called heat transfer fins, or may be referred to as fins. The heating surface elements can be designed as corrugated or ribbed sheets, for example as aluminum sheets. The separating plates are or may be referred to as separating sheets. The separating plates may likewise be made of aluminum. The number of heating surface elements and the number of separating plates are in each case arbitrary. The fact that the heating surface elements and the separating plates are arranged “alternatingly” is to be understood in particular in that a separating plate is in each case arranged between two heating surface elements and a heating surface element is in each case arranged between two separating plates.

The heat exchanger block preferably has a cuboid geometry with a width or x direction, a height or y direction, and a depth or z direction. In the height direction, the heat exchanger block preferably has a larger dimension than in the width direction and depth direction so that an elongated cuboid geometry results. The heating surface elements and the separating plates are preferably stacked one above the other in the depth direction. Each separating sheet, in particular a front side of each separating sheet, preferably spans a plane defined by the width direction and the height direction.

The heating surface elements are preferably enclosed with the aid of edge strips, in particular aluminum edge strips, which are likewise part of the heat exchanger block. The edge strips are soldered to the separating plates and/or heating surface elements. The heat exchanger block may have cover plates that terminate the heat exchanger block forwardly and rearwardly in the depth direction. The cover plates may be external separating plates. The cover plates are soldered to outermost heating surface elements.

The solder layers being “provided” at the separating plates can mean that the solder layers are firmly connected to, for example plated onto, the separating plates. However, the solder layers may also be applied to the separating plates in any other suitable manner. The solder layers are thus preferably part of the separating plates. A “soldered connection” is to be understood as a bonded connection where the heating surface elements and the separating plates are connected to one another with the aid of a solder, in the present case with the aid of an aluminum solder. In the case of bonded connections, the connection partners are held together by atomic or molecular forces. Bonded connections are non-releasable connections that can only be separated by destroying the connecting means and/or the connection partners. During soldering, a surface alloy is produced, but the components to be connected, namely the heating surface elements and the separating plates, are not melted depthwise. In the present case, the heating surface elements and the separating plates are preferably brazed to one another.

The solder layer can be seen as a plane or surface that is divided into several solder areas. That is to say, the solder areas are positioned next to one another and not one above the other. The number of different solder areas is arbitrary. However, at least two different solder areas are provided. That at least a “part” of the separating plates in each case has a solder layer with several differing solder areas conversely means that separating plates that in each case have a solder layer with a homogeneous alloy composition may also be provided.

In particular, the solder areas of a solder layer that differ in their alloy compositions or metallurgical compositions have different melting ranges. In the present case, the “melting range” is to be understood as a temperature interval between the solidus temperature and the liquidus temperature of the solder used for the respective solder area. The melting range is thus a temperature range in which the respective solder area melts. The solidus temperature characterizes the temperature of the solder at and below which the solder is completely in the solid phase. The liquidus temperature denotes the temperature of the solder at and below which the mixture begins to solidify from a homogeneously liquid phase. Between the solidus and the liquidus temperatures, the mixture is pasty in the case of alloys; solid and liquid phases are simultaneously present.

According to one embodiment, the solder areas have differing melting ranges.

Preferably, at least a first solder area is provided, which has a first solder, in particular a first aluminum solder. Furthermore, at least a second solder area is provided, which has a second solder, in particular a second aluminum solder. The first solder and the second solder differ in their alloy compositions in such a way that the first solder has a higher melting range than the second solder or vice versa. The number of solder areas and thus the number of solders used is basically arbitrary.

According to a further embodiment, the solder areas are arranged such that a temperature gradient of the melting ranges is formed in such a way that starting from outer surfaces of the heat exchanger block the melting ranges decrease towards a core of the heat exchanger block.

In the present case, the “core” of the heat exchanger block is to be understood as a region thereof that is arranged furthest away from the outer surfaces in the interior of the heat exchanger block. For example, the core may be cuboid or spherical. When heat is introduced into the outer surfaces of the heat exchanger block, the core is last to heat up. Preferably provided are six outer surfaces, which define the cuboid shape of the heat exchanger block. In the present case, the “temperature gradient” is to be understood as the melting ranges continuously decreasing in their temperature range and running from the outer surfaces towards the core. That is to say, the solder areas in the core begin to melt at a lower temperature than solder areas close to the outer surfaces.

According to a further embodiment, the heat exchanger block has a width direction, a height direction, and a depth direction, wherein the temperature gradient of the melting ranges is provided in each of the directions and running from the outer surfaces towards the core.

In other words, a three-dimensional temperature gradient is thus achieved starting from the outer surfaces and running towards the core.

According to a further embodiment, in the case of the separating plates that comprise solder layers having at least two solder areas that differ in their alloy compositions, the solder areas are placed next to one another on the respective separating plate.

The solder areas thus form flat sections of the solder layer on the separating plates, which sections are arranged next to one another. The solder layer is thus divided into several solder areas. As previously mentioned, each solder area is assigned a solder, in particular an aluminum solder that differs in its alloy composition and thus in its melting range from the adjacent solder area.

According to a further embodiment, a first solder area and a second solder area are provided, wherein the first solder area has a higher melting range than the second solder area, and wherein the second solder area is surrounded by the first solder area.

For example, the second solder area may be placed centrally at or on the respective separating plate and may have a rectangular geometry. The first solder area then preferably surrounds the second solder area in the shape of a frame and encloses it, in particular in the width direction and in the height direction.

According to a further embodiment, a third solder area is provided, wherein the second solder area has a higher melting range than the third solder area, wherein the third solder area is surrounded by the second solder area.

The third solder area is preferably placed centrally at or on the respective separating plate and has a rectangular geometry. The second solder area then preferably surrounds and encloses the third solder area in the shape of a frame. The first solder area preferably surrounds and encloses the second solder area in the shape of a frame.

According to a further embodiment, the separating plates in each case have an aluminum sheet to which the respective solder layer is applied.

For example, the solder layer may be applied as a solder plating to the aluminum sheet. However, the solder layer may also be applied to the aluminum sheet in any other suitable manner.

According to a further embodiment, the solder layer is applied to the aluminum sheet on one side or on both sides.

In particular, the aluminum sheet has a front side and a rear side facing away from the front side. Both the front side and the rear side can be provided with a solder layer. It is also possible for only the front side or only the rear side to have a solder layer.

Furthermore, a process engineering plant with such a plate heat exchanger is proposed.

The process engineering plant may comprise a plurality of such plate heat exchangers. The process engineering plant may, for example, be a plant for air separation, for producing liquid gas, a plant used in the petrochemical industry, or the like.

Furthermore, a method for producing a heat exchanger block for a plate heat exchanger of a process engineering plant is proposed. The method comprises the following steps: a) providing a plurality of heating surface elements; b) providing a plurality of separating plates; c) providing solder layers at the separating plates, wherein, in at least a part of the separating plates, the solder layers comprise at least two solder areas that differ in their alloy compositions, d) alternatingly arranging the heating surface elements and the separating plates, and e) introducing heat into the heating surface elements and the separating plates in order to solder them with the aid of the solder layers to form the heat exchanger block.

In step a), aluminum sheets, for example, can be corrugated or ribbed. In step b), aluminum sheets, for example, are appropriately cut to size. Steps a) and b) may be carried out simultaneously or sequentially. Step c) may be carried out together with, before, or after step b). In step c), the solder layers are plated on, for example. However, the solder layers may also be applied to the separating plates in any other suitable manner. In step d), the heating surface elements and the separating plates are in particular alternatingly arranged in such a way that a separating plate is arranged between two heating surface elements and vice versa. The cover plates and the edge strips may also be added in step d). In step e), the heat is preferably introduced with the aid of a soldering furnace into the heating surface elements and the separating plates in order to solder them, in particular braze them, with the aid of the solder layers to form the heat exchanger block.

According to one embodiment, in step c), in the part of the separating plates in which the solder layers comprise at least two solder areas that differ in their alloy compositions, these solder areas are provided in such a way that a decreasing temperature gradient of melting ranges of the solder areas starting from outer surfaces of the heat exchanger block and running towards a core of the heat exchanger block is formed in the heat exchanger block.

In other words, the different solder areas melt at lower temperatures starting from the outer surfaces and running towards the core. That is to say, a solder area arranged in the core melts at a lower temperature than a solder area arranged in the region of the outer surfaces. A “decreasing” temperature gradient is accordingly to be understood as the melting ranges becoming lower starting from the outer surfaces and running towards the core.

According to a further embodiment, in step e), the heat is introduced in such a way that a decreasing temperature gradient is formed starting from the outer surfaces and running towards the core.

That is to say, the heat exchanger block is not brought to the same temperature throughout. This reduces the soldering time.

According to a further embodiment, in step c), in the part of the separating plates in which the solder layers comprise at least two solder areas that differ in their alloy compositions, these solder areas are provided in such a way that the solder areas are placed next to one another on the respective separating plate.

The different solder areas may be applied simultaneously or sequentially to the respective separating plate. As previously mentioned, each separating plate spans a plane in which or on which the different solder areas are placed next to one another.

According to a further embodiment, in step c), in the part of the separating plates in which the solder layers comprise at least two solder areas that differ in their alloy compositions, a first solder area and a second solder area are provided, wherein the first solder area has a higher melting range than the second solder area, and wherein the second solder area is provided such that it is surrounded by the first solder area.

As previously mentioned, the number of different solder areas is arbitrary. For example, a third solder area that has a lower melting range than the second solder area may be provided. Here the third solder area can be arranged such that the second solder area surrounds the third solder area, in particular in the shape of a frame.

The embodiments and explanations given for the plate heat exchanger apply correspondingly to the process engineering plant and the method and vice versa.

In the present case, “a” is not necessarily to be understood as limiting to precisely one element. It is rather the case that several elements, such as two, three, or more, may also be provided. Any other number word used herein is also not to be understood as a limitation being given to precisely the number of elements mentioned. It is rather the case that, unless otherwise indicated, the number may deviate upwardly or downwardly.

Further possible implementations of the plate heat exchanger, of the process engineering plant, and/or of the method also comprise not explicitly mentioned combinations of embodiments or features described above or below with respect to the exemplary embodiments. The person skilled in the art will also add individual aspects as improvements or additions to the respective basic form of the plate heat exchanger, of the process engineering plant, and/or of the method.

Further advantageous embodiments and aspects of the plate heat exchanger, of the process engineering plant, and/or of the method are the subject-matter of the dependent claims and of the exemplary embodiments of the plate heat exchanger, of the process engineering plant, and/or of the method described below. The plate heat exchanger, the process engineering plant, and/or the method are explained below in more detail on the basis of preferred embodiments with reference to the accompanying figures.

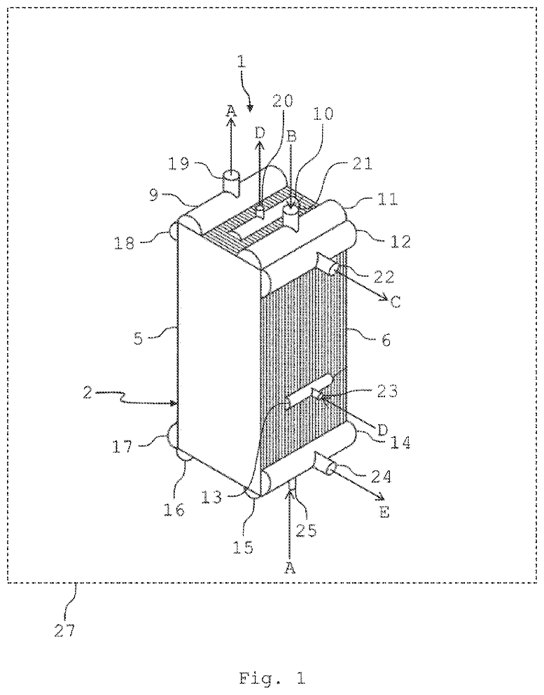

FIG. 1 shows a schematic perspective view of an embodiment of a plate heat exchanger;

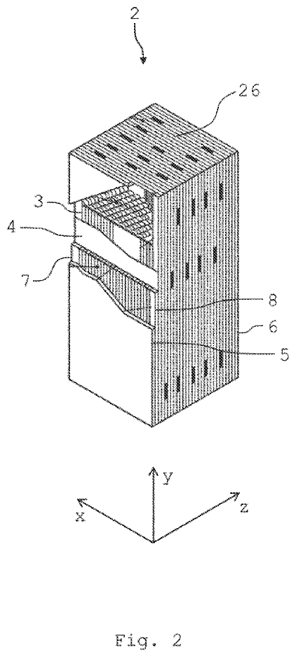

FIG. 2 shows a schematic perspective view of an embodiment of a heat exchanger block for the plate heat exchanger according to FIG. 1;

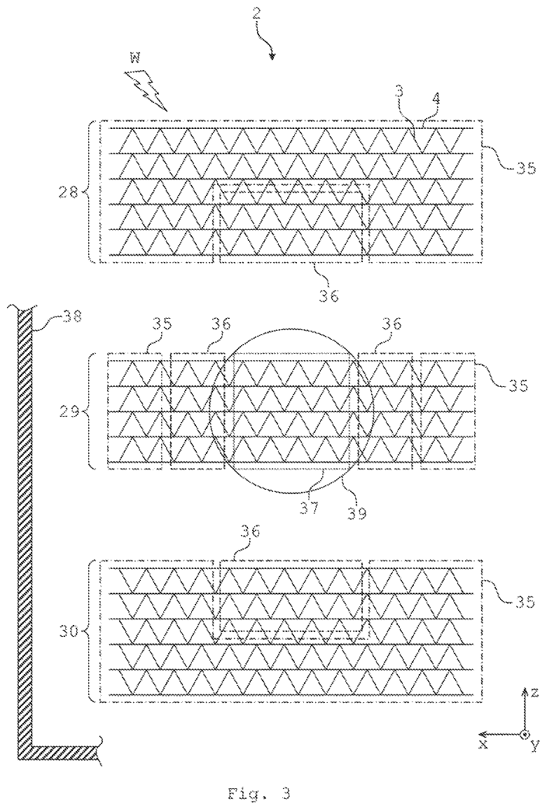

FIG. 3 shows a highly schematic side view of the heat exchanger block according to FIG. 2;

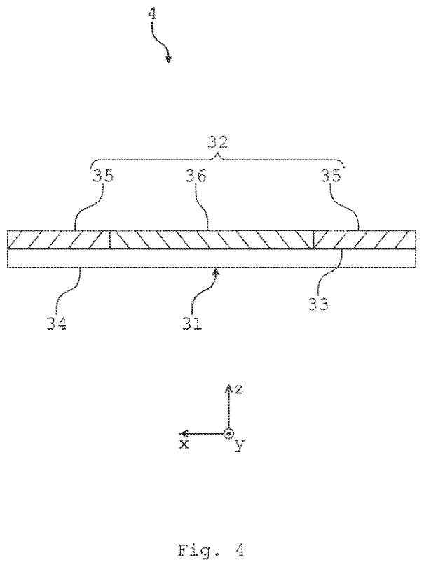

FIG. 4 shows a schematic sectional view of an embodiment of a separating plate for the heat exchanger block according to FIG. 2;

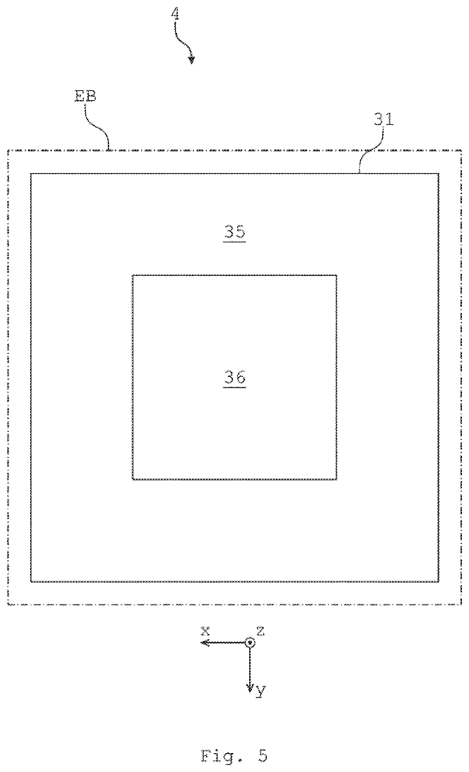

FIG. 5 shows a schematic top view of the separating plate according to FIG. 4;

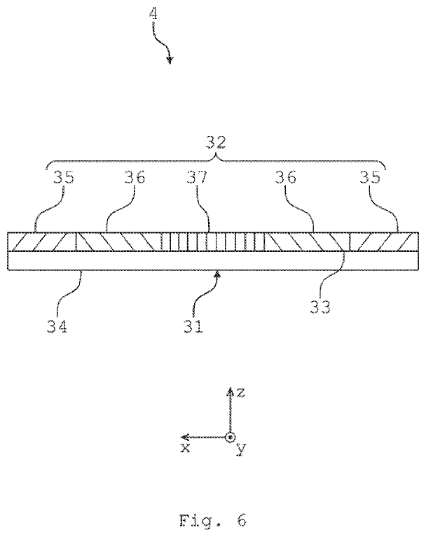

FIG. 6 shows a schematic sectional view of a further embodiment of a separating plate for the heat exchanger block according to FIG. 2;

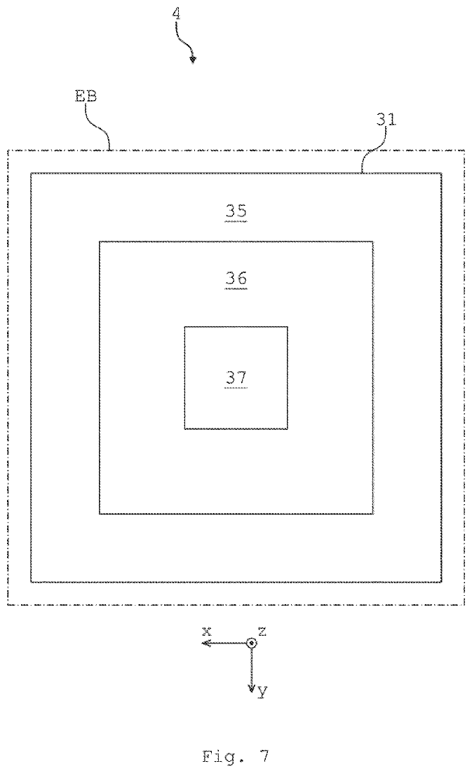

FIG. 7 shows a schematic top view of the separating plate according to FIG. 6; and

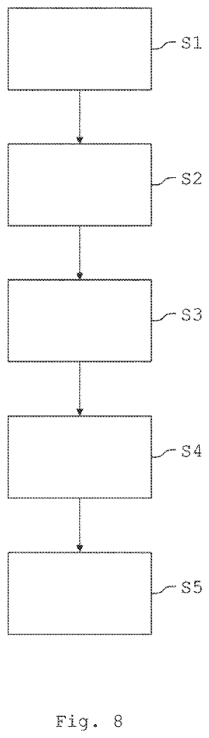

FIG. 8 shows a schematic block diagram of an embodiment of a method for producing a plate heat exchanger according to FIG. 2.

In the figures, the same or functionally equivalent elements have been provided with the same reference symbols unless otherwise stated.

FIG. 1 shows a schematic perspective view of an embodiment of a plate heat exchanger 1. FIG. 2 shows a schematic perspective view of an embodiment of a heat exchanger block 2 for the plate heat exchanger 1 according to FIG. 1. In the following, reference is made simultaneously to FIGS. 1 and 2.

With the aid of the plate heat exchanger 1 shown in FIG. 1, heat exchange between several different fluids A to E can be realized. The fluids A to E may also be referred to as process media or media. The plate heat exchanger 1 is in particular a plate-fin heat exchanger (PFHE) or may be referred to as such. The plate heat exchanger 1 is preferably constructed of components that are made of aluminum and soldered, in particular brazed, together. The plate heat exchanger 1 may therefore also be referred to as a brazed aluminum plate-fin heat exchanger.

The heat exchanger block 2 is cuboid or block-shaped and comprises a plurality of passages or heating surface elements 3 as well as a plurality of separating plates 4. The heating surface elements 3 are so-called fins, in particular so-called heat transfer fins, or may be referred to as fins. The heating surface elements 3 can be designed as corrugated or ribbed sheets, for example as aluminum sheets. The separating plates 4 are or may be referred to as separating sheets. The separating plates 4 may likewise be made of aluminum. The number of heating surface elements 3 and the number of separating plates 4 is in each case arbitrary.

A coordinate system with a first spatial direction or width direction x, a second spatial direction or height direction y, and a third spatial direction or depth direction z is assigned to the heat exchanger block 2. The directions x, y, z are oriented perpendicularly to one another. The width direction x may also be referred to as the x direction of the heat exchanger block 2. The height direction y may also be referred to as the y direction of the heat exchanger block 2. The depth direction z may also be referred to as the z direction of the heat exchanger block 2.

The heating surface elements 3 and the separating plates 4 are alternatingly arranged. That is to say, a separating plate 4 is in each case positioned between two heating surface elements 3, and a heating surface element 3 is in each case positioned between two separating plates 4. The heating surface elements 3 and the separating plates 4 may be bonded to one another. In the case of bonded connections, the connection partners are held together by atomic or molecular forces. Bonded connections are non-releasable connections that can only be separated by destroying the connecting means and/or the connection partners. In particular, the heating surface elements 3 and the separating plates 4 may be soldered, in particular brazed, together.

The heat exchanger block 2 furthermore comprises cover plates 5, 6 between which the plurality of heating surface elements 3 and the plurality of separating plates 4 are arranged. The cover plates 5, 6 may be of identical construction to the separating plates 4. The cover plates 5, 6 are positioned on the outside of a respective outermost heating surface element 3 and terminate the heat exchanger block 2 frontwardly and rearwardly in the orientation of FIGS. 1 and 2. Furthermore, the heat exchanger block 2 comprises so-called side bars or edge strips 7, 8, which laterally delimit the heating surface elements 3. The edge strips 7, 8 may be bonded, for example soldered, in particular brazed, to the separating plates 4 and/or the heating surface elements 3. The aforementioned components of the heat exchanger block 2 are made, for example, from the material 3003 (AlMn1Cu).

With the aid of the heating surface elements 3 and the separating plates 4, the plate heat exchanger 1 forms a plurality of parallel heat transfer passages in which the fluids A to E can flow and can indirectly transfer heat to fluids A to E being conducted in adjacent heat transfer passages. The individual heat transfer passages can be supplied with a respective fluid A to E with the aid of connection devices 9 to 18, or the respective fluid A to E can be conducted away from the plate heat exchanger 1 with the aid of such a connection device 9 to 18. The connection devices 9 to 18 are so-called headers or may be referred to as such. Depending on the function, the connection devices 9 to 18 may also be referred to as distributors or collectors.

For example, the connection devices 11, 13, 15 are suitable for supplying the fluids A, B, D to the plate heat exchanger 1, and the connection devices 9, 10, 12, 14 are suitable for discharging the fluids A, C, D, E from the plate heat exchanger 1. Each connection device 9 to 18 is assigned a connector 19 to 25, with the aid of which the respective connection device 9 to 18 can be supplied with the corresponding fluid A to E or the corresponding fluid A to E can be conducted away from the connection device 9 to 18. The connection devices 9 to 18 are bonded to the heat exchanger block 2. In particular, the connection devices 9, 18 are welded to the heat exchanger block 2. The connection devices 9 to 18 may also be soldered to the heat exchanger block 2.

The heat exchanger block 2 comprises several, in particular six, surfaces or outer surfaces 26, only one of which is provided with a reference symbol in FIG. 2. For example, the connection devices 9 to 18 are respectively welded to one of the outer surfaces 26. The connection devices 9 to 11 may, for example, be provided on the outer surface 26 provided with a reference symbol in FIG. 2.

The plate heat exchanger 1 can be part of a process engineering plant 27. The process engineering plant 27 can comprise, for example, a plant for air separation, for producing liquid gas (liquefied natural gas, LNG), a plant used in the petrochemical industry, or the like. The process engineering plant 27 may comprise a plurality of such plate heat exchangers 1.

As previously mentioned, the components of the plate heat exchanger 1 are preferably made of an aluminum alloy. For strength reasons, an aluminum alloy with a high magnesium content, such as the material 5083 (AlMg4.5Mn) or a comparable material, is preferably used for the connection devices 9 to 18. Such aluminum alloys with a high magnesium content have a magnesium content of about 4 to 5%. Such aluminum alloys have a high strength.

In order to produce the heat exchanger block 2, its individual parts, namely the heating surface elements 3, the separating plates 4, the cover plates 5, 6, and the edge strips 7, 8 are soldered, in particular brazed, together in a soldering furnace under vacuum using an aluminum solder. In doing so, the aluminum solder may be applied to the separating plates 4 on one side or on both sides as a solder layer, in particular as a solder plating.

Usually, an aluminum soldering alloy having a relatively narrow and high melting range is used. In order to be able to reliably solder the individual components of the heat exchanger block 2 together, it is necessary to reach the melting temperature of the aluminum solder being used, both in the core and at the edge of the heat exchanger block 2. Since the heat exchanger block 2 slowly heats up from its edge towards its core in the soldering furnace, the aluminum solder at the edge of the heat exchanger block 2 is in a molten range for several hours. In contrast, the aluminum solder in the core is only in the molten range for a few minutes.

This can result in long soldering times, which should be avoided in the interests of economic production. Furthermore, unfavorable effects and reactions can occur between the separating plates 4 and the heating surface elements 3 due to the long soldering times at the edge of the heat exchanger block 2. Particularly the local formation of low-melting Al—Si eutectics, which may have a negative impact due to erosion phenomena on the heating surface elements 3, should be avoided. In this case, holes and/or notches can be eaten into the heating surface elements 3, which can manifest as a lower burst pressure or operating pressure than in the qualifications of the heating surface elements 3. In particular with higher and wider designs of the heat exchanger block 2, this can represent a strongly limiting factor.

FIG. 3 highly schematically shows an embodiment of a heat exchanger block 2 in which the aforementioned effects are avoided. As previously mentioned, the heat exchanger block 2 comprises a plurality of heating surface elements 3 and separating plates 4 soldered together, only one of each of which is provided with a reference symbol in FIG. 3. FIG. 3 shows only a top layer 28, a middle layer 29, and a bottom layer 30, which in each case have a plurality of heating surface elements 3 and separating plates 4. The layers 28 to 30 are arranged one above the other in the depth direction z in such a way that the middle layer 29 is arranged between the layers 28, 30. Between the layers 28 to 30, a plurality of further layers can be provided, each having a plurality of heating surface elements 3 and separating plates 4. These aforementioned layers are, however, not shown in FIG. 3.

FIG. 4 shows a not-to-scale sectional view of an embodiment of a separating plate 4 arranged in one of the layers 28, 30. The separating plate 4 comprises an aluminum sheet 31 to which, as shown in FIG. 4, a solder layer 32, in particular an aluminum solder, is applied on one side or also on both sides (not shown). The aluminum sheet 31 comprises a front side 33 on which the solder layer 32 is provided, and a rear side 34 facing away from the front side 33. The rear side 34 may also be provided with such a solder layer 32.

The solder layer 32 comprises a first solder area 35 and a second solder area 36. The solder areas 35, 36 differ in their alloy compositions or in their metallurgical compositions. That is to say, aluminum solders having different alloy compositions are used for the solder areas 35, 36.

As shown in FIG. 5, the first solder area 35 surrounds the second solder area 36 in the width direction x and in the height direction y. However, this does not necessarily have to be provided in this way. Aluminum soldering alloys having a relatively narrow and high melting range are used for the first solder area 35. An aluminum solder having a melting range of 575 to 630° C. is used for the first solder area 35.

For example, aluminum soldering alloys of the Al—Si type, for example Al105, Al107, or Al112, may be used for the first solder area 35. In FIG. 3, regions of the heat exchanger block 2 in which the separating plates 4 have the first solder area 35 are enclosed with dot-dash lines. Each separating plate 4, in particular its front side 33, spans a plane EB in the width direction x and in the height direction y. On this plane EB, the solder areas 35, 36 are placed next to one another.

In comparison to the first solder area 35, the second solder area 36 has an aluminum soldering alloy that melts at lower temperatures. An aluminum solder having a melting range of 555 to 595° C. is used for the second solder area 36. For example, aluminum soldering alloys of the Al—Si—Mg type, for example Al310 or Al311, may be used for the second solder area 36. In FIG. 3, regions of the heat exchanger block 2 in which the separating plates 4 have the second solder area 36 are enclosed with dot-dash lines.

FIG. 6 shows a not-to-scale sectional view of an embodiment of a separating plate 4 arranged in the middle layer 29. As previously mentioned, the separating plate 4 comprises an aluminum sheet 31 to which the solder layer 32 is applied on one side or also on both sides (not shown). The solder layer 32 comprises a third solder area 37 in the middle layer 29 in addition to the first solder area 35 and the second solder area 36. The solder areas 35, 36, 37 differ in their alloy compositions or in their metallurgical compositions. That is to say, aluminum solders having different alloy compositions are used for the solder areas 35, 36, 37.

As shown in FIG. 7, the first solder area 35 and the second solder area 36 may enclose the third solder area 37 in such a way that the second solder area 36 is arranged between the first solder area 35 and the third solder area 37 when viewed in the width direction x and when viewed in the height direction y. However, this does not necessarily have to be provided in this way. In the aforementioned plane EB, the solder areas 35 to 37 are placed next to one another.

In comparison to the second solder area 36, the third solder area 37 has an aluminum soldering alloy that melts at lower temperatures. An aluminum solder having a melting range of 520 to 585° C. or 595° C. is used for the third solder area 37. For example, aluminum soldering alloys of the Al—Si—Mg type or Al—Si—Cu type, for example Al319, Al210, or Al410, may be used for the third solder area 37. In FIG. 3, a region of the heat exchanger block 2 in which the separating plates 4 have the third solder area 37 is enclosed by dot-dash lines.

The functionality of the separating plates 4 with their differently composed solder layers 32 is explained below. The heating surface elements 3 and separating plates 4 stacked alternatingly on top of one another are heated in a soldering furnace 38 shown only partially in FIG. 3, wherein heat W is introduced into the components of the heat exchanger block 2. In FIG. 3, the cover plates 5, 6 and the edge strips 7, 8 are not shown for a simplified illustration.

With the aid of the introduced heat W, the heat exchanger block 2 not yet soldered is heated slowly from the outer surfaces 26 (FIG. 2) in the direction of a core 39 of the heat exchanger block 2. As already previously mentioned, the cuboid heat exchanger block 2 comprises six outer surfaces 26, only one of which is provided with a reference symbol in FIG. 2. In the present case, the “core” 39 of the heat exchanger block 2 is to be understood as a region of the heat exchanger block 2 that is arranged furthest from the six outer surfaces 26. The core 39 is thus provided centrally in the heat exchanger block 2. In FIG. 3, the core 39 is shown in a very simplified manner with a circular or spherical shape. However, the core 39 may have any other three-dimensional shape. Like the heat exchanger block 2 itself, the core 39 may be cuboid.

Until the heat exchanger block 2 is completely heated, i.e., until both the outer surfaces 26 and the core 39 have the same temperature, a temperature gradient is formed running from the outer surfaces 26 in the direction of the core 39. This is to be understood as the temperature decreasing from the outer surfaces 26 in the direction of the core 39 or the temperature increasing from the core 39 in the direction of the outer surfaces 26. Due to the different melting ranges of the solder areas 35 to 37, this temperature gradient can be utilized in order to melt the solder areas 35 to 37 almost simultaneously, wherein it is not necessary to heat the heat exchanger block 2 in such a way that the core 39 and the outer surfaces 26 have the same temperature.

The solder areas 35 to 37 also have a temperature gradient as regards their melting ranges such that the melting temperature of the respective solder areas 35 to 37 decreases from the outer surfaces 26 and running towards the core 39. As previously mentioned, the first solder area 35 arranged close to the outer surfaces 26 has the highest melting range, and the third solder area 37 arranged close to the core 39 has the lowest melting range. The melting range of the second solder area 36 lies between the melting ranges of the solder areas 35, 37. The temperature gradient of the melting ranges of the solder areas 35 to 37 thus follows the temperature gradient within the heat exchanger block 2 when the same is heated.

It is thus possible to utilize the temperature gradient during heating of the heat exchanger block 2 in such a way that even if the heat exchanger block 2 is not yet completely heated through, all solder areas 35 to 37 are melted almost simultaneously due to their different melting ranges. As a result, complete heating of the heat exchanger block 2 can be dispensed with. This shortens soldering times, in particular in the case of heat exchanger blocks 2 having large dimensions. Furthermore, the aforementioned undesired effects and reactions between the separating plates 4 and the heating surface elements 3 at the edge, i.e., in the region of the outer surfaces 26, of the heat exchanger block 2 can be prevented. In particular, the local formation of low-melting Al—Si eutectics can thereby be avoided.

A temperature gradient of the melting range of the solder layers 32 of the separating plates 4 can thus be achieved in all three directions x, y, z. The separating plates 4 can thus be adapted to the respective application. Thus, “tailored” separating plates 4 (tailored brazing sheets) that have different solder layers 32 having differently composed solder areas 35 to 37 depending on the position of the respective separating plate 4 in the heat exchanger block 2 can be produced and used.

FIG. 8 shows in summary a schematic block diagram of an embodiment of a method for producing the heat exchanger block 2. In the method, a plurality of heating surface elements 3 is provided in a step S1. For example, aluminum sheets can be corrugated or ribbed. In a step S2, a plurality of separating plates 4 is provided. Aluminum sheets 31 are appropriately cut for this purpose, for example. Steps S1 and S2 may be carried out simultaneously or sequentially.

In a step S3, solder layers 32 are provided on the separating plates 4, wherein, as previously mentioned, in at least a part of the separating plates 4, the solder layers 32 comprise at least two solder areas 35 to 37 that differ in their alloy compositions. Step S3 may be carried out together with, before, or after step S2.

Subsequently, in a step S4, the heating surface elements 3 and the separating plates 4 are alternatingly arranged in such a way that a separating plate 4 is arranged between two heating surface elements 3 and vice versa. Here, the cover plates 5, 6 and the edge strips 7, 8 may also be added. In a final step S5, heat W is introduced with the aid of a soldering furnace 38 into the heating surface elements 3 and the separating plates 4 in order to solder, in particular braze, them with the aid of the solder layers 32 to form the heat exchanger block 2.

Preferably, in the part of the separating plates 4 in which the solder layers 32 comprise at least the two solder areas 35 to 37 that differ in their alloy compositions, these solder areas 35 to 37 are provided in step S3 in such a way that a decreasing temperature gradient of the melting ranges of the solder areas 35 to 37 is formed in the heat exchanger block 2 starting from the outer surfaces 26 of the heat exchanger block 2 and running towards the core 39 of the same. “Decreasing” in this case means that the melting ranges decrease in temperature from the outer surfaces 26 in the direction of the core. Accordingly, in step S4, the heat W is introduced in such a way that a decreasing temperature gradient is formed starting from the outer surfaces 26 and running towards the core 39. It is possible to dispense with heating the heat exchanger block 2 through in such a way that it has the same temperature both at the outer surfaces 26 and in the core 39.

In step S3, in the part of the separating plates 4 in which the solder layers 32 comprise at least the two solder areas 35 to 37 that differ in their alloy compositions, these solder areas 35 to 37 are provided in such a way that the solder areas 35 to 37 are placed next to one another on the respective separating plate 4 or on or in the plane EB. The number of different solder areas 35 to 37 is basically arbitrary.

Furthermore, in step S3, the first solder area 35 and the second solder area 36 are provided in the part of the separating plates 4 in which the solder layers 32 comprise at least the two solder areas 35 to 37 that differ in their alloy compositions, wherein the first solder area 35 has a higher melting range than the second solder area 36. In this case, the second solder area 36 is provided such that it is surrounded by the first solder area 35. In this step S3, the third solder area 37 may also be provided.

A reduction in soldering times can thus advantageously be achieved with the heat exchanger block 2 or with the method. Furthermore, heat exchanger blocks 2 having larger dimensions can be soldered without the aforementioned disadvantages. The formation of Al—Si eutectics can be prevented, which is accompanied by an increase in the burst pressures.

Although the present invention has been described with reference to exemplary embodiments, it can be modified in many ways within the scope of the claims.

### REFERENCE SYMBOLS USED

1 Plate heat exchanger
2 Heat exchanger block
3 Heating surface element
4 Separating plate
5 Cover plate
6 Cover plate
7 Edge strip
8 Edge strip
9 Connection device
10 Connection device
11 Connection device
12 Connection device
13 Connection device
14 Connection device
15 Connection device
16 Connection device
17 Connection device
18 Connection device
19 Connector
20 Connector
21 Connector
22 Connector
23 Connector
24 Connector
25 Connector
26 Outer surface
27 Process engineering plant
28 Layer
29 Layer
30 Layer
31 Aluminum sheet
32 Solder layer
33 Front side
34 Rear side
33 Solder area
36 Solder area
37 Solder area
38 Soldering furnace
39 Core
A Fluid
B Fluid
C Fluid
D Fluid
E Fluid
EB Plane
S1 Step
S2 Step
S3 Step
S4 Step
S5 Step
W Heat
x Width direction
y Height direction
z Depth direction

1-15. (canceled)

16. A plate heat exchanger for a process engineering plant, having a heat exchanger block comprising a plurality of alternatingly arranged heating surface elements and separating plates, wherein the separating plates are soldered to the heating surface elements with the aid of solder layers provided at the separating plates, and wherein, in at least a part of the separating plates, the solder layers comprise at least two solder areas that differ in their alloy compositions.

17. The plate heat exchanger according to claim 16, wherein the solder areas have differing melting ranges.

18. The plate heat exchanger according to claim 17, wherein the solder areas are arranged such that a temperature gradient of the melting ranges is formed in such a way that the melting ranges decrease starting from outer surfaces of the heat exchanger block and running towards a core of the heat exchanger block.

19. The plate heat exchanger according to claim 18, wherein the heat exchanger block has a width direction (x), a height direction (y), and a depth direction (z), and wherein the temperature gradient of the melting ranges is provided in each of the directions (x, y, z) starting from the outer surfaces and running towards the core.

20. The plate heat exchanger according to claim 16, wherein in the separating plates comprising solder layers having at least two solder areas that differ in their alloy compositions, the solder areas are placed next to one another on the respective separating plate.

21. The plate heat exchanger according to claim 20, wherein a first solder area and a second solder area are provided, wherein the first solder area has a higher melting range than the second solder area, and wherein the second solder area is surrounded by the first solder area.

22. The plate heat exchanger according to claim 21, wherein a third solder area is provided, wherein the second solder area has a higher melting range than the third solder area, wherein the third solder area is surrounded by the second solder area.

23. The plate heat exchanger according to claim 16, wherein the separating plates in each case have an aluminum sheet to which the respective solder layer is applied.

24. The plate heat exchanger according to claim 23, wherein the solder layer is applied to the aluminum sheet on one side or on both sides.

25. The process engineering plant having a plate heat exchanger according to claim 16.

26. A method for producing a heat exchanger block for a plate heat exchanger of a process engineering plant, comprising the following steps:
a) providing a plurality of heating surface elements,
a) providing a plurality of separating plates,
c) providing solder layers at the separating plates, wherein, in at least a part of the separating plates, the solder layers comprise at least two solder areas that differ in their alloy compositions,
d) alternatingly arranging the heating surface elements and the separating plates, and
e) introducing heat into the heating surface elements and the separating plates in order to solder them with the aid of the solder layers to form the heat exchanger block.

27. The method according to claim 26, wherein, in step c), in the part of the separating plates in which the solder layers comprise at least two solder areas that differ in their alloy compositions, these solder areas are provided in such a way that a decreasing temperature gradient of melting ranges of the solder areas starting from outer surfaces of the heat exchanger block and running towards a core of the heat exchanger block is formed in the heat exchanger block.

28. The method according to claim 27, wherein, in step e), the heat is introduced in such a way that a decreasing temperature gradient is formed starting from the outer surfaces and running towards the core.

29. The method according to claim 26, wherein, in step c), in the part of the separating plates in which the solder layers comprise at least two solder areas that differ in their alloy compositions, these solder areas are provided in such a way that the solder areas are placed next to one another on the respective separating plate.

30. The method according to claim 29, wherein, in step c), in the part of the separating plates in which the solder layers comprise at least two solder areas that differ in their alloy compositions, a first solder area and a second solder area are provided, wherein the first solder area has a higher melting range than the second solder area, and wherein the second solder area is provided such that it is surrounded by the first solder area.
